(19) United States
(12) Patent Application Publication
(10) Pub. No.: US 2005/0006892 A1
(43) Pub. Date: Jan. 13, 2005

(54) Visor pal

(76) Inventor: Gregory Alan Bridwell, Nashville, TN (US)

Correspondence Address: Gregory A. Bridwell, 6317 Sweetgun, Nashville, TN, 37221, US

(21) Appl. No.: 10/617,302

(22) Filed: Jul. 11, 2003

(51) Int. Cl. G09B 19/00

(52) U.S. Cl. 283/52

(57) ABSTRACT

A multi panel communication device sun visor cover. The cover comprises a multi panel device with several folds, multi-color graphic and text to convey useful information to the driving public. The exposed surfaces are folded in such a way that some are visible in the closed position and others are not. This enables some surfaces to be read with the sun visor in the closed position and others to be read in the open position. An additional surface is added for removable coupons.

### FIELD OF INVENTION

This invention relates generally to a multifold cover for a sun visor to convey useful information with areas for paying advertiser.

### BACKGROUND

In the United States people spend a great amount of time in their cars, the hope of this invention is to give the driving public a tool to use to make the time in their cars more efficient while using the same space to advertise.

### INVENTION SUMMARY

(a) to provide a sun visor cover to consumer at no cost

(b) to provide a sun visor cover that provides useful information to the consumer

(c) to provide a vehicle to sell advertising

(d) to provide free advertising to the businesses that distribute the visors

(e) to provide a source of coupons to the consumer

(f) to provide valuable coupons to the consumer

(g) To be handed out at drive through window

Further objectives is to provide a source of information that will be easy to locate

### DESCRIPTION OF THE PREFERRED EMBODIMENTS

In the crowded world of advertisement, even the slightest difference gives the advertiser a new and unique way of delivering the advertisement. The cover also gives the consumer a useful product. The preferred method of distribution is through drive through windows of fast food restaurants. Other methods are displays in gas stations and at sports events.

### ELEMENTS OF THE INVENTION

As an article of manufacture, the invention comprises a multi folded cover body having a front and back to all the panels onto which can be printed full color graphic of useful information and advertisement with something that can be held in place by device and is removable.

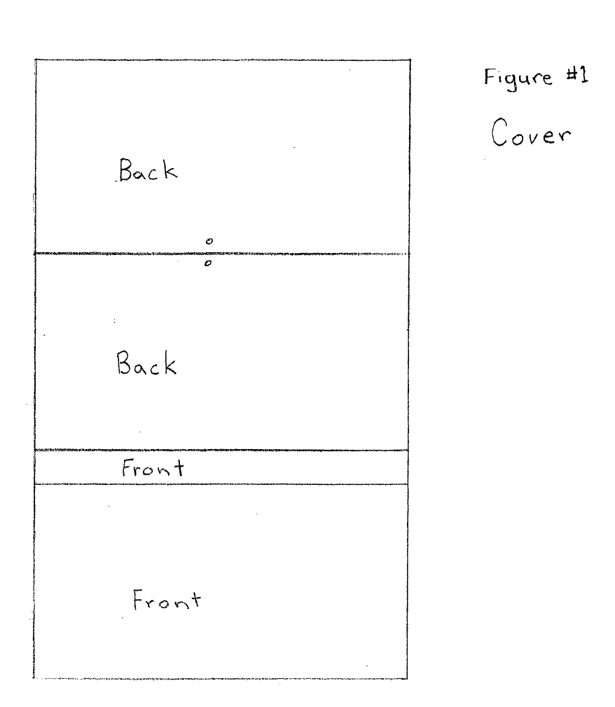

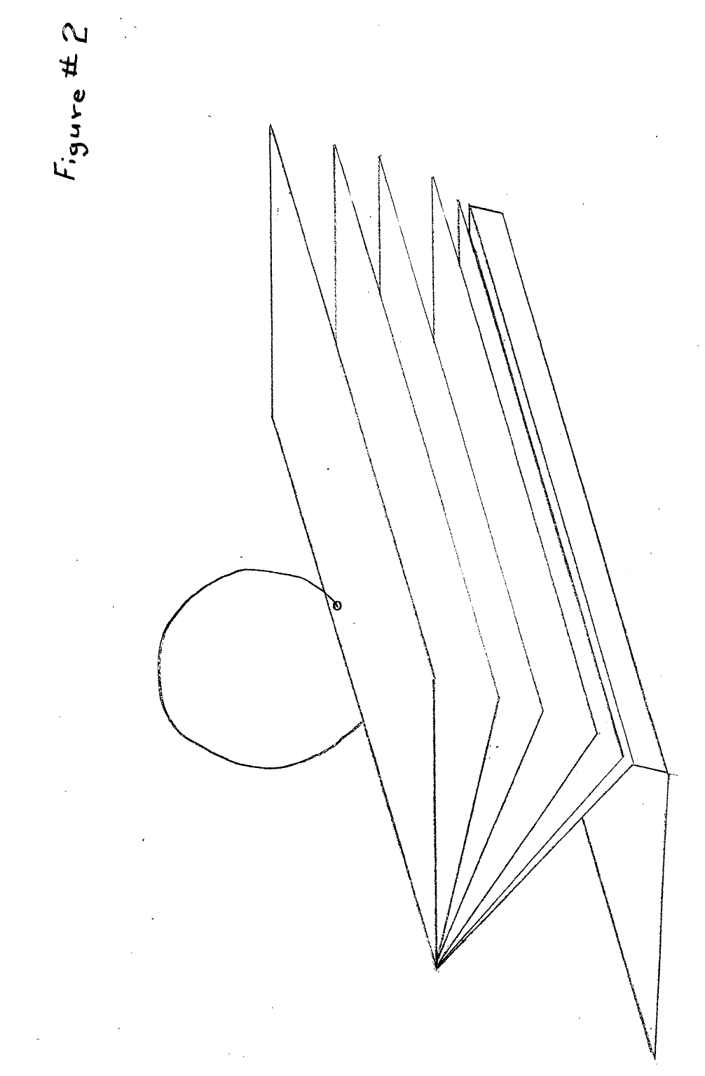

FIGS. 1 and 2 show an example of the first preferred embodiment. The body (FIGS. 1 & 2) of the cover is formed from paper stock or a similar material such as paper, plastic, ect. The thickness is to be sufficient to hold it's shape but light as possible to keep cost down.

The holders should be easy to use and low cost such as elastic bands, Velcro, tape, string, clips, or hooks.

The cover body (FIGS. 1 & 2) has a height of no less that 6 inches and a width of no less than 5 inches.

In the preferred embodiments described in FIGS. 1 and 2, the height and width of the cover body is 14 inches and 12 inches, respectively. It is understood that the invention is not limited to any of the dimensions set forth herein.

For the preferred embodiments with the removable coupons, the recipient would remove the coupons (see FIGS. 1 & 2 section 1s) and present it to the retailer. For other preferred embodiment the recipient would apply stickers before removal.

### SUMMARY, RAMIFICATION, AND SCOPE

The preferred embodiments of the invention is to produce a sun visor cover at a low cost in order to give the recipient a useful item that the recipient can use in their cars that is also an advertisement tool. The invention would be a unique way to advertise products and to distribute free advertisement.

The invention is a multi folded sun visor cover held in place with a low cost devise. This invention is intended to allow the recipient to use their time in the car more efficiently.

Although the description above contains many specifications these should not be construed as limiting the scope of the invention but as merely providing illustrations of some of the presently preferred embodiments of this invention. For example, the cover could have other shapes and dimensions; the number of fold may change depending on the size of the market. In other embodiments there may be thanks attached such as pitchers, gifts, more coupons ect.

It is to be understood that future modifications may be made which will be obvious to those of ordinary skill in the art. Therefore, I do not limit myself to the previous constructions herein disclosed and the right is reserved to all changes and modifications coming within the scope of the invention as defined by the appended claims.

1. A communication vehicle comprising:

2. A sheet of stock material. (cardboard or plastic),

3. Said sheet having multi folds,

4. Said sheet having multi surfaces,

5. Multi-colored graphics used to convey useful information such as maps, schedule, phone number ect,

6. Said graphic being the principal means of communication,

7. Surface to have removable coupons

8. The primary configuration is a booklet with a cover that is folded, so that it holds the booklet on the sun visor displays information.
